(19) United States
(12) Patent Application Publication
(10) Pub. No.: US 2022/0347746 A1
(43) Pub. Date: Nov. 3, 2022

(54) METHOD FOR REFINING LARGE-PARTICLE-SIZE PURE COPPER OR COPPER ALLOY PARTICLES BY HIGH-ENERGY BALL MILLING

(71) Applicant: SOUTH CHINA UNIVERSITY OF TECHNOLOGY, Guangzhou (CN)

(72) Inventors: Weiping CHEN, Guangzhou (CN); Fazhan WANG, Guangzhou (CN); Fangfang LIU, Guangzhou (CN)

(73) Assignee: SOUTH CHINA UNIVERSITY OF TECHNOLOGY, Guangzhou (CN)

(21) Appl. No.: 17/638,198

(22) PCT Filed: Aug. 25, 2020
(86) PCT No.: PCT/CN2020/111163

§ 371 Date: Feb. 25, 2022

(30) Foreign Application Priority Data
Aug. 26, 2019 (CN) 201910788291.8

(51) Int. Cl. B22F 9/04; B22F 1/05; B22F 9/22

(52) U.S. Cl. CPC B22F 9/04; B22F 1/05; B22F 9/22; B22F 2009/043

(57) ABSTRACT

The present invention discloses a method for refining large-particle-size pure copper or copper alloy particles by high-energy ball milling, the method comprising the following steps: (1) using large-particle-size pure copper or copper alloy coarse particles as a raw material and cyclohexane or water as a process control agent, and crushing and refining the particles by high-energy ball milling to obtain small-particle-size copper or copper alloy powder; and (2) decreasing an oxygen content in the powder obtained in step (1) in a reducing atmosphere to obtain pure copper or copper alloy powder. In the present invention, by improving the overall process flow of the preparation method and the parameter conditions of each process step, the method greatly decreases energy consumption compared with existing copper powder preparation techniques. In addition, the method features a simple process and low production costs.

### TECHNICAL FIELD

The present invention relates to the technical field of powder preparation, in particular to a method for refining large-particle-size pure copper or copper alloy particles by high-energy ball milling.

### BACKGROUND

The invention and development of lubricated porous bronze bearings in the 1920s have greatly promoted the industrial production of copper powder. The earliest copper powder production methods are reduction of copper oxides and electrolysis. In the 1930s, copper powder produced on a large scale by displacement and precipitation began to be applied to copper-based friction materials. In the 1950s, the atomization method and hydrometallurgy method were successively developed, by which large-scale production was realized.

Copper oxide reduction is an old method, in which copper scales generated during copper processing are reduced, and then crushed into copper powder. The particle size of copper powder prepared by this method is generally quite large, so the current production output is small. Electrolytic preparation of copper powder comes from the production of electrolytic copper. It mainly involves increasing the current density and reducing the concentration of copper ions so as to obtain electrolytic copper powder. The prepared copper powder is dendritic and has good formability. At present, the annual output of electrolytic copper powder accounts for more than 70% of pure copper powder, making electrolysis the main preparation method. However, the production of copper powder by electrolysis is related to high energy consumption and severe environmental pollution. Atomization is a method that uses a high-pressure fluid to act on a molten metal flow, or quickly crushes molten metal into powder with the help of centrifugal force, mechanical force, etc. Among many atomization methods, a two-fluid atomization method is used the most. It is a method that generates a high-speed and high-pressure medium flow through an atomizing nozzle to crush a melt into fine droplets which are then cooled and solidified into powder. The atomizing medium is generally water or gas, corresponding to water atomization or gas atomization respectively. The atomization methods is associated with complicated process steps and high energy consumption.

High-energy ball milling generally refers to refining powder in a solid state by means of mechanical energy, which is a material preparation method for preparing nano powder, alloy or compounds. In the process of ball milling, the impact of grinding balls makes powder particles subjected to deformation, soldering and breakage repeatedly under different ball milling parameters, allowing the powder to be more and more refined over time. Ball milling has the advantages of simple process, low energy consumption and low pollution.

For metals with body-centered cubic and close-packed hexagonal structures, thus being poor in plasticity, high-energy ball milling has a good refining effect. However, for metals with face-centered cubic structures, such as copper, which can slip in three directions at room temperature, thus being good in ductility, it is generally considered that ball milling hardly generates a good refining effect.

At present, the research on refining copper particles by high-energy ball milling mainly focuses on the preparation of ultrafine powder with copper powder less than 75 μm in particle size, but there is basically no study on the ball milling refining process for large copper particles over 100 μm.

### SUMMARY

### Technical Problems and Solution to Problems

### Technical Solution

In view of the above defects or improvement requirements of the related art, the present invention aims to provide a method for refining large-particle-size pure copper or copper alloy particles by high-energy ball milling. By improving the overall process flow of the preparation method and the parameter conditions of each process step (such as types and proportioning of additives and processing parameters such as processing time, especially process control agents used for ball milling, proportioning of raw materials, ball-mill rotation speed, etc.), the method has the advantages of low energy consumption and low pollution compared with the related art. By adding appropriate process control agents, the particles are subjected to in-situ surface modification while being refined, so that the surface energy of the particles and the interface energy between the particles and ball milling bodies are reduced, the dispersibility of powder is improved, soldering between the refined particles is slowed down, and the refinement of large copper particles is realized.

The purpose of the present invention is achieved by at least one of the following technical schemes.

A method for refining large-particle-size pure copper or copper alloy particles by high-energy ball milling comprises the following steps:

(1) using large-particle-size pure copper or copper alloy coarse particles as a raw material and cyclohexane or water as a process control agent, and crushing and refining the particles by high-energy ball milling to obtain small-particle-size copper or copper alloy powder; and

(2) decreasing an oxygen content in the copper or copper alloy powder obtained in step (1) in a reducing atmosphere to obtain pure copper or copper alloy powder. Because the presence of a small amount of copper oxide and cuprous oxide, the powder obtained after ball milling cannot be used directly. The copper oxide and cuprous oxide need to be reduced to copper.

Further, the material of grinding balls used in step (1) is selected from bearing steel or copper, and when bearing steel grinding balls are adopted, the small-particle-size copper or copper alloy powder obtained in step (1) needs to be treated with a leaching solution, filtered after leaching to remove impurities introduced by ball milling, and then dried before step (2).

Further, in step (1), the process control agent and the raw material are mixed at a fluid-to-material ratio of 0.2-2 ml/g, and the sizes of the pure copper or alloy coarse particles are 100-650 μm.

Further, in step (2), pure hydrogen or decomposed ammonia is used as the reducing atmosphere.

Further, in step (1), the mass ratio of grinding balls to the raw material during the high-energy ball milling treatment is 15:1-50:1. A planetary ball mill is used for high-energy ball milling.

Further, in step (1), the ball milling treatment is carried out for 6-20 h at a ball-mill rotation speed of 200-500 rpm, and the particle sizes obtained after ball milling are 7-45 μm.

Further, the filtration is preferably vacuum filtration, and the drying is vacuum drying.

Further, the leaching solution is dilute hydrochloric acid, dilute sulfuric acid, an aqueous solution of copper chloride or an aqueous solution of copper sulfate.

Further, in step (2), a reduction temperature is 200-750° C. and a reduction time is 1-2 h; and for the pure copper or alloy powder obtained after reduction, the oxygen content is less than 0.3 wt % and an iron content is less than 0.06 wt %.

Further, when the sizes of the large-particle-size pure copper or alloy coarse particles are greater than 250 μm, the large-particle-size pure copper or alloy coarse particles are first rolled into tablets before high-energy ball milling is carried out.

### Advantages of the Invention

### Advantages

In view of the fact that large copper particles are difficult to mill due to their good ductility, the high-energy ball milling method and the process control agent are used for in-situ surface modification of the particles, which improves the dispersibility and brittleness of the powder, slows down the soldering between the refined particles and achieves the purpose of refining large copper particles. The difficulty of the present invention lies in the selection of an appropriate process control agent. In the invention, large copper particles are the ball milling refining object, cyclohexane or water is used as the process control agent, and the copper particles are refined by means of mechanical force. By optimizing the ball milling process, the method has the following effects:

(1) the method is suitable for copper particles in different sizes, and has a good refining effect for large copper particles with particle sizes ranging from 100 μm to 650 μm, which shows that the method has good practicability; in addition, the whole copper powder preparation process is simple, pollution and energy consumption are low, and the problems of high investment, high pollution and high energy consumption of traditional copper powder preparation processes are overcome; and

(2) high-efficiency powder preparation can be achieved by refining large-particle-size pure copper or alloy particles by high-energy ball milling; the process control agent is used for in-situ surface modification of the particles, so that the surface energy of the particles and the interface energy between the particles and ball milling bodies are reduced, the dispersibility and brittleness of powder are improved, soldering between the refined particles is slowed down, and crushing and refinement of large copper particles is realized; the leaching solution is then used for removing iron impurities introduced by ball milling, and finally pure copper powder is obtained in a reducing atmosphere; and the high-energy ball milling method for pure copper powder preparation features strong operability and a simple process, the prepared powder has small particle sizes and high purity, the oxygen content in the pure copper or alloy powder is less than 0.3 wt %, and the iron content is less than 0.11 wt %.

### BRIEF DESCRIPTION OF DRAWINGS

### Description of Drawings

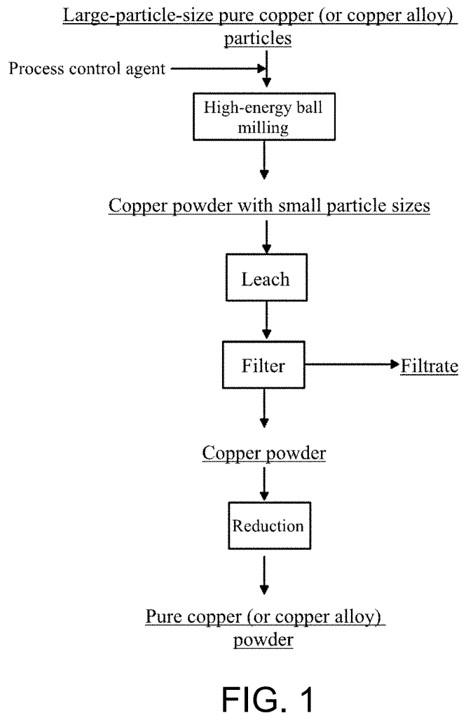

FIG. 1 is a process flowchart of a high-energy ball milling method for pure copper powder preparation.

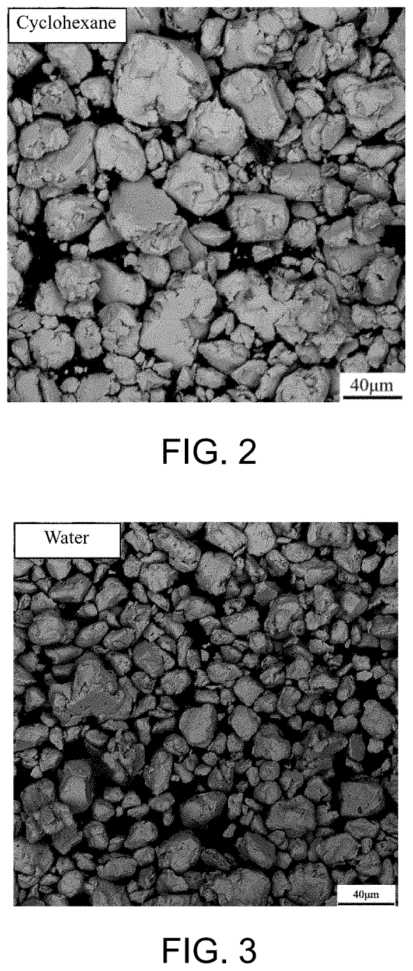

FIG. 2 is a micrograph of fine materials obtained by high-energy ball milling crushing and refinement in Embodiment 2.

FIG. 3 is a micrograph of fine materials obtained by high-energy ball milling crushing and refinement in Embodiment 6.

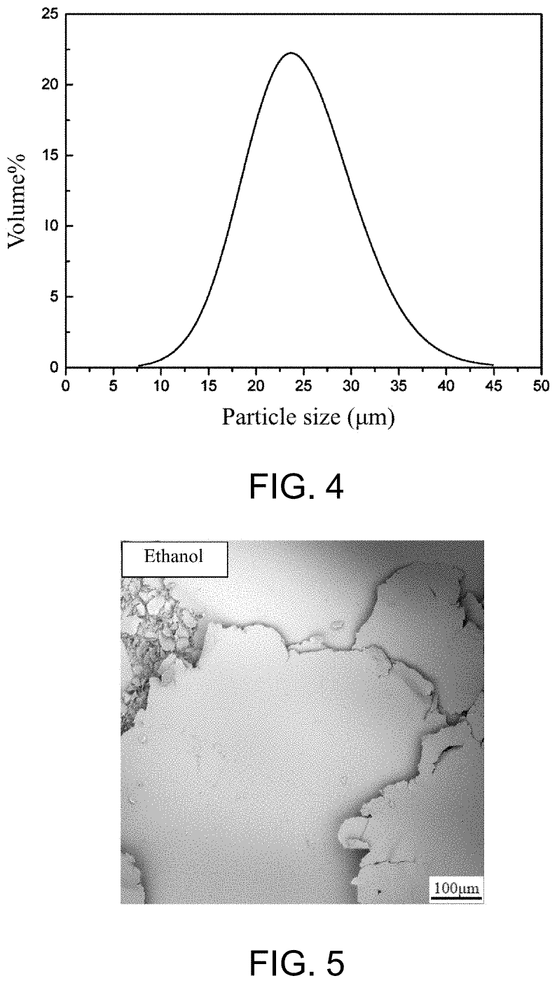

FIG. 4 is a particle size distribution diagram of materials obtained by ball milling refinement under optimal conditions in Embodiment 6.

FIG. 5 is a micrograph of materials obtained by high-energy ball milling crushing and refinement in a comparative example.

### DETAILED DESCRIPTION

### Embodiments of the Invention

In order to make the objectives, technical schemes and advantages of the present invention more apparent, the present invention is further described in detail in conjunction with the accompanying drawings and embodiments. It should be understood that the specific embodiments described here are only intended to explain the present invention and are not intended to limit the present invention. In addition, the technical features involved in various embodiments of the present invention described below can be combined with each other as long as they do not conflict with each other.

An embodiment of the present invention provides a method for refining large-particle-size pure copper or copper alloy particles by high-energy ball milling. Hydrochloric acid is used as a leaching agent to leach out iron impurities introduced by ball milling, pure copper or alloy powder is obtained after filtration and drying, and finally the oxygen content in the powder is decreased through reduction to obtain pure copper or alloy powder which can be used in powder metallurgy. The method for refining large pure copper particles to prepare pure copper or alloy powder comprises the steps as shown in FIG. 1.

At S1, the large-particle-size pure copper or alloy particles and a process control agents are co-ground in a planetary ball mill first, then materials obtained after ball milling are screened by a 200-mesh standard sieve, and the optimal ball-milling parameters are determined by the sieving rate of copper powder.

At S2, ball milling is carried out on the large-particle-size pure copper or alloy particles according to the optimal conditions obtained in S1, and the process control agent is separated from the copper powder through a vacuum filtration device to obtain fine copper powder.

At S3, hydrochloric acid, for example, is used as a leaching agent to leach iron impurities introduced by ball milling through chemical leaching, then a leaching solution is separated from the copper powder through a vacuum filtration device, and vacuum drying is carried out to obtain pure copper or alloy powder.

At S4, the pure copper or alloy powder obtained in S3 is reduced by a reducing gas such as hydrogen to decrease the oxygen content in the powder, thus obtaining pure copper or alloy powder which can be used in powder metallurgy.

The present invention will be further explained in detail by taking copper particles with different particle sizes as experimental objects, and using a process control agent for in-situ surface modification of the particles, which improves the dispersibility and brittleness of the powder and slows down the soldering between refined particles.

### Embodiment 1

Pure copper particles with particle sizes of 100-250 μm were used as the experimental object. Cyclohexane was used as the process control agent, and the addition amount of cyclohexane relative to the raw material was 1 ml/g. The two were put into a 250 ml stainless steel ball milling tank. The mass ratio of grinding balls to the raw material was 20:1, the diameter of the grinding balls was 5 mm, and the material of the grinding balls was GCr15 steel. High-energy ball milling was carried out in a planetary ball mill. High-energy ball milling time was set to be 6 h, and the ball-mill rotation speed was set to be 500 rpm. After ball milling, the materials were leached by 2 mol/L hydrochloric acid and then filtered to obtain copper powder, and then vacuum drying and reduction were carried out successively to obtain pure copper powder. Pure hydrogen was used as a reducing atmosphere, reduction temperature was 750° C., and reduction time was 2 h. The oxygen content of the pure copper powder was 0.1% and the iron content was 0.08%. In this case, the sieving rate of the pure copper powder through a 200-mesh sieve was 88.1%.

### Embodiment 2

Pure copper particles with particle sizes of 100-250 μm were used as the experimental object. Cyclohexane was used as the process control agent, and the addition amount of cyclohexane relative to the raw material was 1 ml/g. The two were put into a 250 ml stainless steel ball milling tank. The mass ratio of grinding balls to the raw material was 40:1, the diameter of the grinding balls was 5 mm, and the material of the grinding balls was GCr15 steel. High-energy ball milling was carried out in a planetary ball mill. High-energy ball milling time was set to be 8 h, and the ball-mill rotation speed was set to be 400 rpm. After ball milling, the materials were leached by 2 mol/L hydrochloric acid and then filtered to obtain copper powder, and then vacuum drying and reduction were carried out successively to obtain pure copper powder. Pure hydrogen was used as a reducing atmosphere, reduction temperature was 300° C., and reduction time was 5 h. The oxygen content of the pure copper powder was 0.3% and the iron content was 0.08%. In this case, the sieving rate of the pure copper powder through a 200-mesh sieve was over 88.5%. FIG. 2 is a micrograph of the pure copper powder, and the refined powder is granular.

### Embodiment 3

Pure copper particles with particle sizes of 650-250 μm were used as the experimental object, which were mechanically rolled into tablets before ball milling refinement. Water was used as the process control agent, and the addition amount of water relative to the raw material was 1 ml/g. The two were put into a 250 ml stainless steel ball milling tank. The mass ratio of grinding balls to the raw material was 20:1, the diameter of the grinding balls was 5 mm, and the material of the grinding balls was GCr15 steel. High-energy ball milling was carried out in a planetary ball mill. High-energy ball milling time was set to be 10 h, and the ball-mill rotation speed was set to be 400 rpm. After ball milling, the materials were leached by 2 mol/L hydrochloric acid and then filtered to obtain copper powder, and then vacuum drying and reduction were carried out successively to obtain pure copper powder. Pure hydrogen was used as a reducing atmosphere, reduction temperature was 400° C., and reduction time was 2 h. The oxygen content of the pure copper powder was 0.3% and the iron content was 0.08%. In this case, the sieving rate of the pure copper powder through a 200-mesh sieve was over 95.5%.

### Embodiment 4

Copper alloy particles with particle sizes of 100-250 μm were used as the experimental object. Cyclohexane was used as the process control agent, and the addition amount of cyclohexane relative to the raw material was 0.2 ml/g. The two were put into a 250 ml stainless steel ball milling tank. The mass ratio of grinding balls to the raw material was 15:1, the diameter of the grinding balls was 5 mm, and the material of the grinding balls was GCr15 steel. High-energy ball milling was carried out in a planetary ball mill. High-energy ball milling time was set to be 20 h, and the ball-mill rotation speed was set to be 500 rpm. After ball milling, the materials were leached by 2 mol/L hydrochloric acid and then filtered to obtain powder, and then vacuum drying and reduction were carried out successively to obtain copper alloy powder. Pure hydrogen was used as a reducing atmosphere, reduction temperature was 550° C., and reduction time was 1 h. The oxygen content of the copper alloy powder was 0.3% and the iron content was 0.11%. In this case, the sieving rate of the copper alloy powder through a 200-mesh sieve was over 99.5%.

### Embodiment 5

Copper alloy particles with particle sizes of 100-250 μm were used as the experimental object. Water was used as the process control agent, and the addition amount of water relative to the raw material was 2 ml/g. The two were put into a 250 ml stainless steel ball milling tank. The mass ratio of grinding balls to the raw material was 50:1, the diameter of the grinding balls was 5 mm, and the material of the grinding balls was GCr15 steel. High-energy ball milling was carried out in a planetary ball mill. High-energy ball milling time was set to be 20 h, and the ball-mill rotation speed was set to be 300 rpm. After ball milling, the materials were leached by 2 mol/L hydrochloric acid and then filtered to obtain powder, and then vacuum drying and reduction were carried out successively to obtain copper alloy powder. Pure hydrogen was used as a reducing atmosphere, reduction temperature was 550° C., and reduction time was 1 h. The oxygen content of the copper alloy powder was 0.3% and the iron content was 0.07%. The sieving rate of the copper alloy powder through a 200-mesh sieve was over 87.5%.

### Embodiment 6

Pure copper particles with particle sizes of 100-250 μm were used as the experimental object. Water was used as the process control agent, and the addition amount of water relative to the raw material was 1 ml/g. The two were put into a 250 ml stainless steel ball milling tank. The mass ratio of grinding balls to the raw material was 20:1, the diameter of the grinding balls was 5 mm, and the material of the grinding balls was GCr15 steel. High-energy ball milling was carried out in a planetary ball mill. High-energy ball milling time was set to be 7 h, and the ball-mill rotation speed was set to be 400 rpm. After ball milling, the materials were leached by 2 mol/L hydrochloric acid and then filtered to obtain copper powder, and then vacuum drying and reduction were carried out successively to obtain pure copper powder. Pure hydrogen was used as a reducing atmosphere, reduction temperature was 550° C., and reduction time was 1 h. The oxygen content of the pure copper powder was 0.3% and the iron content was 0.08%. The sieving rate of the pure copper powder through a 200-mesh sieve was over 98.8%. FIG. 3 is a micrograph of the pure copper powder, and the refined powder is granular. FIG. 4 is a particle size distribution diagram of the pure copper powder, and the particle sizes are 7-45 μm.

### Comparative Example

The preparation conditions of this comparative example are the same as those of Embodiment 6, except that the process control agent was replaced by ethanol. The product obtained in this comparative example is shown in FIG. 5. The material obtained after ball milling was in the form of large tablets, which shows that it is difficult to refine copper particles with ethanol as the process control agent.

Those skilled in the art can easily understand that the above are only preferred embodiments of the present invention, and are not used to limit the present invention. Any modification, equivalent substitution and improvement made within the spirit and principle of the present invention should be included in the protection scope of the present invention.

1. A method for refining large-particle-size pure copper or copper alloy particles by high-energy ball milling, the method comprising the following steps:
(1) using large-particle-size pure copper or copper alloy coarse particles as a raw material and cyclohexane or water as a process control agent, and crushing and refining the particles by high-energy ball milling to obtain small-particle-size copper or copper alloy powder; and (2) decreasing an oxygen content in the copper or copper alloy powder obtained in step (1) in a reducing atmosphere to obtain pure copper or copper alloy powder.

2. The method of claim 1, wherein the material of grinding balls used in step (1) is selected from bearing steel or copper, and when bearing steel grinding balls are adopted, the small-particle-size copper or copper alloy powder obtained in step (1) is treated with a leaching solution, filtered after leaching to remove impurities introduced by ball milling, and then dried before step (2).

3. The method of claim 1, wherein in step (1), the process control agent and the raw material are mixed at a fluid-to-material ratio of 0.2-2 ml/g, and the sizes of the large-particle-size pure copper or copper alloy coarse particles are 100-650 μm.

4. The method of claim 1, wherein in step (2), pure hydrogen or decomposed ammonia is used as the reducing atmosphere.

5. The method of claim 1, wherein in step (1), the mass ratio of grinding balls to the raw material during the high-energy ball milling is 15:1-50:1.

6. The method of claim 1, wherein in step (1), the ball milling is carried out for 6-20 h at a ball-mill rotation speed of 200-500 rpm.

7. The method of claim 2, wherein the filtration is vacuum filtration, and the drying is vacuum drying.

8. The method of claim 2, wherein the leaching solution is dilute hydrochloric acid, dilute sulfuric acid, an aqueous solution of copper chloride or an aqueous solution of copper sulfate.

9. The method of claim 1, wherein in step (2), a reduction temperature is 300-750° C. and a reduction time is 1-5 h; and for the pure copper or copper alloy powder obtained after reduction, the oxygen content is less than 0.3 wt % and an iron content is less than 0.11 wt %.

10. The method of claim 3, wherein when the sizes of the large-particle-size pure copper or copper alloy coarse particles are greater than 250 μm, the large-particle-size pure copper or copper alloy coarse particles are first rolled into a sheet form before high-energy ball milling is carried out.
